(19) United States
(12) Patent Application Publication
(10) Pub. No.: US 2024/0087170 A1
(43) Pub. Date: Mar. 14, 2024

(54) METHOD FOR MULTIVIEW PICTURE DATA ENCODING, METHOD FOR MULTIVIEW PICTURE DATA DECODING, AND MULTIVIEW PICTURE DATA DECODING DEVICE

(71) Applicant: GUANGDONG OPPO MOBILE TELECOMMUNICATIONS CORP., LTD., Dongguan (CN)

(72) Inventors: Marek DOMANSKI, Poznan (PL); Tomasz GRAJEK, Poznan (PL); Adam GRZELKA, Poznan (PL); Slawomir MACKOWIAK, Poznan (PL); Slawomir ROZEK, Poznan (PL); Olgierd STANKIEWICZ, Poznan (PL); Jakub STANKOWSKI, Poznan (PL)

(21) Appl. No.: 18/514,908

(22) Filed: Nov. 20, 2023

Related U.S. Application Data
(63) Continuation of application No. PCT/CN2021/107996, filed on Jul. 22, 2021.

(30) Foreign Application Priority Data
May 26, 2021 (EP) 21461543.7

(51) Int. Cl. G06T 9/00; G06T 3/40

(52) U.S. Cl. CPC G06T 9/00; G06T 3/4038

(57) ABSTRACT

A method for multiview picture data encoding comprising the steps of: performing extraction of features from multiview picture data to obtain a plurality of feature maps; performing stitching and/or transforming of the obtained plurality of feature maps to obtain at least one panoramic map of features; performing transforming of the multiview picture data to select a plurality of patches of view of the multiview picture data; encoding the at least one panoramic map of features; and encoding the plurality of patches of view.

### CROSS REFERENCE TO RELATED APPLICATION(S)

This application is a continuation of International Application No. PCT/CN2021/107996, filed Jul. 22, 2021, which claims priority to European Patent Application No. 21461543.7, filed May 26, 2021, the entire disclosures of which are incorporated herein by reference.

### TECHNICAL FIELD

The present invention relates to the technical field of compression and decompression of visual information. More specifically, the present invention relates to a method for multiview picture data encoding, a method for multiview picture data decoding, and a multiview picture data decoding device.

### BACKGROUND

Coding is used in a wide range of applications which involve visual information such as pictures, for example, still pictures (such as still images) but also moving pictures such as picture streams and videos. Examples of such applications include transmission of still images over wired and wireless mobile networks, video transmission and/or video streaming over wired or wireless mobile networks, broadcasting digital television signals, real-time video conversations such as video-chats or video-conferencing over wired or wireless mobile networks and storing of images and videos on portable storage media such as DVD disks or Blue-ray disks.

Coding usually involves encoding and decoding. Encoding is the process of compressing and potentially also changing the format of the content of the picture. Encoding is important as it reduces the bandwidth needed for transmission of the picture over wired or wireless mobile networks. Decoding on the other hand is the process of decoding or uncompressing the encoded or compressed picture. Since encoding and decoding is applicable on different devices, standards for encoding and decoding called codecs have been developed. A codec is in general an algorithm for encoding and decoding of pictures.

Reducing the bandwidth needed for transmission of the pictures is particularly important when the picture is a so-called panoramic picture such as a still panoramic image or panoramic video due to, in general, the large size of the panoramic picture. Therefore, for example, a codec may be applied for encoding (compressing) the panoramic picture (for example the panoramic picture data) such that the bandwidth needed for transmission is reduced. In the same time, it is highly desirable that the quality of the encoded (compressed) panoramic picture is preserved as much as possible.

In general, the panoramic picture such as still panoramic picture (such as still panoramic image) but also moving panoramic picture such as panoramic picture stream and panoramic video may also be called or represent a panoramic view. In other words, a panoramic view is generally understood to represent a continues view in a plurality (at least two) of directions. For example, a panoramic view may be a 360° image or 360° video. Such 360° image or 360° video conveys the view of a whole panorama of a scene seen from a given point. The panoramic view may be just a 2D panoramic representation or a representation of an omnidirectional image or video obtained by mapping.

In general, the panoramic view is captured by multiple cameras each looking in a different direction. It is also possible to capture a panoramic view by using one camera which captures multiple views (view being understood in the sense of image or video), each view being captured with the camera looking in a different direction. Hence, a panoramic view may be seen as a multiview, since it is obtained based on several individual (input) views by applying suitable processing on the individual views.

For example, several (at least two) individual (input) views, such as several images or several videos are combined together into a panoramic view on the encoder side. The panoramic view is then encoded (compressed) and transmitted, normally in a form of a bitstream, to a decoding side for decoding as elaborated above.

At the decoding side, normally, feature extraction is applied for extracting features from the decoded panoramic view to reconstruct the panoramic view. However, the accuracy of feature extraction may depend strongly on the coding loss of the decoded panoramic view.

Therefore, there is a need to increase the quality of the reconstructed panoramic view on the decoding side.

### SUMMARY

According to a first aspect of the present invention there is provided a method for multiview picture data encoding comprising the steps of:
performing extraction of features from multiview picture data to obtain a plurality of feature maps;
performing stitching and/or transforming of the obtained plurality of feature maps to obtain at least one panoramic map of features;
performing transforming of the multiview picture data to select a plurality of patches of view of the multiview picture data;
encoding the at least one panoramic map of features; and
encoding the plurality of patches of view.

According to a second aspect of the present invention there is provided a method for multiview picture data decoding comprising the steps of:
obtaining at least one encoded panoramic map of features;
performing decoding of the obtained at least one encoded panoramic map of features;
obtaining a plurality of encoded patches of view of a multiview picture data;
performing decoding on the obtained plurality of encoded patches of view;
performing extraction of features from the decoded plurality of patches of view to obtain a plurality of feature maps; and
performing matching of the obtained plurality of feature maps with said decoded panoramic map of features to obtain the position of each patch of view of the plurality of patches of view in a panoramic picture data.

According to a third aspect of the present invention there is provided a multiview picture data decoding device comprising a processor and an access to a memory to obtain code that instructs said processor during operation to:
obtain at least one encoded panoramic map of features;
perform decoding of the obtained at least one encoded panoramic map of features;
obtain a plurality of encoded patches of view of a multiview picture data;
perform decoding on the obtained plurality of encoded patches of view;
perform extraction of features from the decoded plurality of patches of view to obtain a plurality of feature maps; and
perform matching of the obtained plurality of feature maps with said decoded panoramic map of features to obtain the position of each patch of view of the plurality of patches of view in a panoramic picture data.

### BRIEF DESCRIPTION OF THE DRAWINGS

Embodiments of the present invention, which are presented for better understanding the inventive concepts, but which are not to be seen as limiting the invention, will now be described with reference to the figures in which:

FIG. 1A shows a schematic view of general use case as in the conventional arts as well as an environment for employing embodiments of the present invention;

FIG. 1B shows a schematic view of a conventional configuration for encoding and decoding;

FIG. 1C shows schematically a conventional approach pipeline for transmission from an encoding side to a decoding side;

FIG. 2A shows schematically configuration for encoding and decoding multiview picture data according to the embodiment of the present invention;

FIG. 2B shows schematically a pipeline for transmission of multiview picture data according to the embodiment of the present invention;

FIG. 3A shows a schematic view of a general device embodiment for the encoding side according to an embodiment of the present invention;

FIG. 3B shows a schematic view of a general device embodiment for the decoding side according to an embodiment of the present invention;

FIGS. 4A & 4B show flowcharts of general method embodiments of the present invention;

### DETAILED DESCRIPTION

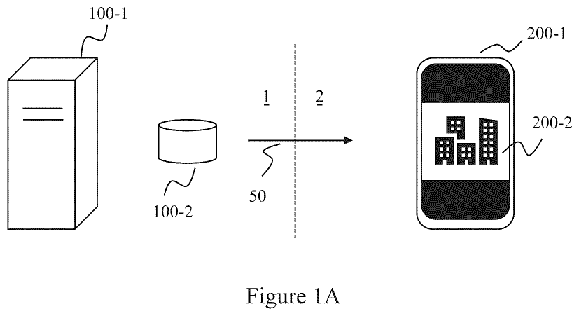

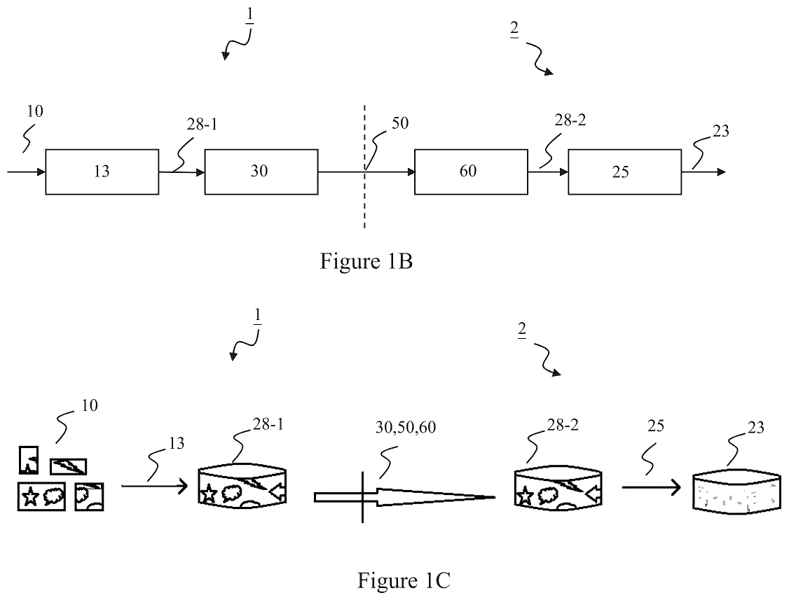

FIG. 1A shows a schematic view of a general use case as in the conventional arts as well as an environment for employing embodiments of the present invention. On the encoding side 1 there is arranged equipment 100-1, 100-2, such as data centres, servers, processing devices, data storages and the like that is arranged to store and process multiview picture data and generate one or more bitstreams by encoding the multiview picture data.

Generally, the term multiview picture data in the description here below refers to picture data relating to more than one view. In other words, multiview picture data comprises a plurality of individual views. The plurality of individual views may also be seen to represent a plurality of viewports or plurality of directions from a specific viewpoint. Each one of the individual views is and/or includes data that is, contains, indicates and/or can be processed to obtain an image, picture, a stream of pictures/images, a video, a movie and the like, wherein, in particular, a stream, a video or a movie may contain one or more images.

For simplicity, in the description here below, the term view is used in the sense of image or video. The image or the video may be monochromatic or colour image or video. Accordingly, multiview picture data may comprise a plurality of individual images or videos. Each individual view is captured by at least one image capturing unit (for example camera), each image capturing unit looking at a different direction outward from a viewpoint. It is also possible that each individual view is captured by a single image capturing unit, said image capturing unit looking in a different direction outward from a viewpoint when capturing each individual view.

By further processing such multiview picture data panoramic picture data on the decoding side may be obtained as elaborated further below. Panoramic picture data may be understood as data that is, contains, indicates and/or can be processed to obtain at least in part a (reconstructed) panoramic view. The panoramic view includes data that is, contains, indicates and/or can be processed to obtain a panoramic image, a panoramic picture, a stream of panoramic pictures/images, a panoramic video, a panoramic movie, and the like, wherein, in particular, a panoramic stream, panoramic video or a panoramic movie may contain one or more pictures. For simplicity, in the description here below the term panoramic view is used in the sense of panoramic image or panoramic video. The word reconstructed may be seen as indicating that the data is a reconstruction at least in part on the decoding side 2 of the corresponding data on the encoding side 1.

Hence, a panoramic view may be seen as a multiview, since it is obtained based on several individual (input) views.

In general, panoramic view is a continuous view of a scene in at least two directions. The panoramic view may represent the scene in different manners, such as cylindrical, cubic, spherical and etc.

For example, the panoramic view may be a 360° image or 360° video. Such 360° image or 360° video conveys the view of a whole panorama of a scene seen from a given point. Panoramic view may also be just a 2D panoramic representation or a representation of an omnidirectional image or video obtained by any mapping.

On the encoding side 1 the one or more generated bitstreams are conveyed 50 via any suitable network and data communication infrastructure toward the decoding side 2, where, for example, a mobile device 200-1 is arranged that receives the one or more bitstreams, decodes them and processes them to generate panoramic picture data which as elaborated above may be and/or contain and/or indicate and/or can be processed to obtain a (reconstructed) panoramic view for displaying it on a display 200-2 of the (target) mobile device 200-1 or are subjected to other processing on the mobile device 200-1.

FIG. 1B shows a schematic view of the conventional configuration for encoding and decoding of multiview picture data and FIG. 1C shows schematically the pipeline for transmission of multiview picture data from an encoding side 1 to a decoding side 2.

Multiview picture data 10, which, as elaborated above, may comprise a plurality of individual views such as a plurality of individual images or videos, captured, for example, by a plurality of cameras are combined in one panoramic view 28-1 on the encoder side 1. The plurality of individual views may also be called here below a plurality of input views. Combining may comprise for example stitching 13 together the plurality of individual views 10 in a stitcher 13 provided in the encoding side 1 to thereby generate a single panoramic view 28-1. An encoder 30 provided in the encoded side 1 encodes the generated panoramic view 28-1 and the encoded panoramic view 28-1 is then transmitted 50 to the decoding side 2 normally in a form of one or more bitstreams.

On the decoding side 2, there is provided a decoder 60 in which it is performed decoding of the received encoded panoramic view 28-1 to thereby obtain a decoded panoramic view 28-2. A feature extractor 25 is further provided on the decoding side 2, in which it is performed extraction of features (feature extraction) from the decoded panoramic view 28-2 to thereby obtain a panoramic map of features 23. The extraction of features in the feature extractor 25 may involve for example Scale-Invariant Feature Transform (SIFT) keypoints extraction. Thus, a panoramic map of features 23 needs to be available on the decoding side 2. The obtained panoramic map of features 23 is then used on the decoding side 2 to, at least partly reconstruct, the panoramic view 28-2 from the received encoded panoramic view on the decoding side 2.

As elaborated above, the accuracy of feature extraction in the feature extractor 25 depends strongly on the coding loss of the decoded panoramic view 28-2. Reduced accuracy of the step of feature extraction reduces in turn the accuracy and hence the quality of the at least partly reconstructed panoramic view.

Therefore, the present invention aims at increasing the quality of the at least partly reconstructed panoramic view on the decoding side 2.

For this, the present invention proposes that the complete panoramic map of features is transmitted from the encoding side 1 to the decoding side 2 and further proposes building (or reconstructing) the panoramic view on the decoding side 2 from the received panoramic map of features and patches of view, as elaborated further below. Patch of view, as also elaborated here below, refers to a single (individual) view from the plurality of individual views, its fragment or combination of fragments. In other words, each patch of view, in the description here below is any one of an individual view, a part of an individual view or a combination of at least two parts of an individual view. Hence, according to the present invention the panoramic view does not need to be produced on the encoding side 1, as elaborated above, in respect to the panoramic view 28-1.

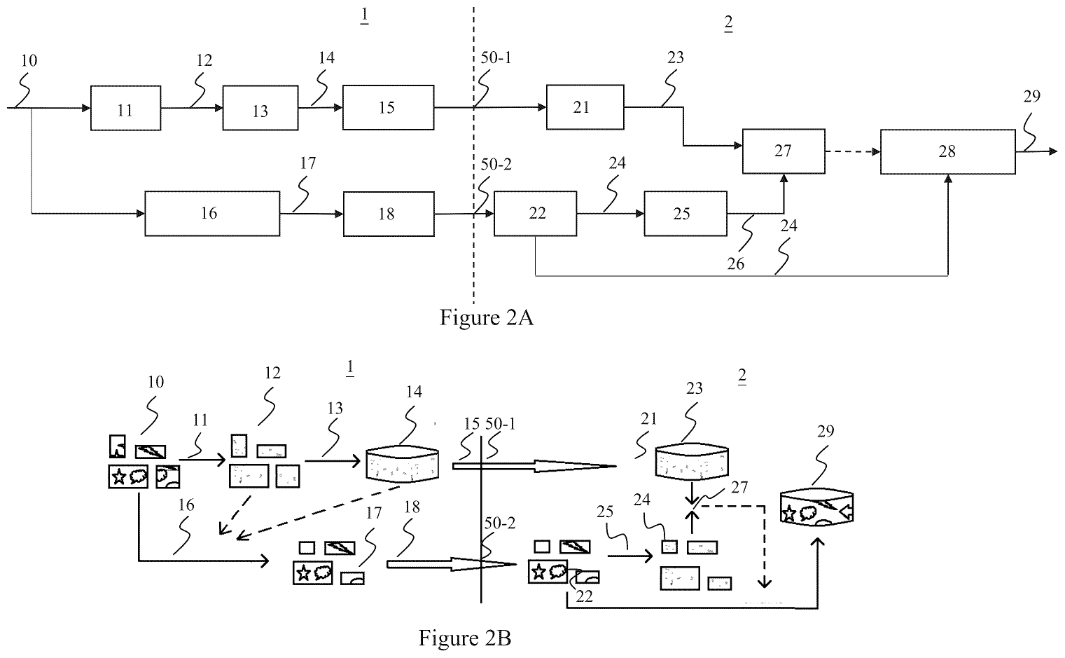

FIG. 2A shows schematically the configuration for multiview picture data encoding and multiview picture data decoding according to the embodiment of the present invention. FIG. 2B shows schematically a pipeline of transmission multiview picture data according to the embodiment of the present invention.

As elaborated above, multiview picture data 10 are obtained on the encoding side. As elaborated above, the multiview picture data 10 comprise a plurality of individual views. In this embodiment, each one of the individual views is captured by at least one image capturing unit, each image capturing unit looking in a different direction outward from a viewpoint. Accordingly, obtaining the multiview picture data 10 may be understood as receiving on the encoding side 1 the plurality of individual views from, for example, the corresponding image capturing units, and/or any other information processing, device and/or other encoding device.

In the encoding side 1 there is provided a feature extractor 11 in which it is performed extraction of features from the multiview picture data 10 to obtain a plurality of feature maps 12. More specifically, in the feature extractor 11 it is performed extraction of features from each individual view of the multiview picture data 10 to thereby obtain at least one feature map 12 for each individual view. For simplicity, it may be considered that the number of feature maps 12 is equal to the number of individual views of the multiview picture data 10.

In the feature extractor 11 the extraction of features is performed by applying a predetermined feature extraction method. The extracted features may be seen to represent small fragments in the corresponding individual view of the multiview picture data 10. Each feature, in general, comprises a feature key point and a feature descriptor. The feature key point may represent the fragment 2D position. The feature descriptor may represent visual description of the fragment. The feature descriptor is generally represented as a vector, also called a feature vector.

The predetermined feature extraction method may result in the extraction of discrete features. For example, the feature extraction method may comprise any one of scale-invariant feature transform, SIFT, method, compact descriptors for video analysis, CDVA, method or compact descriptors for visual search, CDVS, method.

In other embodiment of the present invention the predetermined feature extraction method may also apply linear or non-linear filtering. For example, the feature extractor 11 may be a series of neural-network layers that extract features from the multiview picture data 10 through linear or non-linear operations. The series of neural-network layers may be trained based on a given data. The given data may be a set of images which have been annotated with what object classes are present in each image. The series of neural-network layers may automatically extract the most salient features with respect to each specific object class.

For example, in embodiments of the present invention, the predetermined feature extraction method may be, for example, the Scale-Invariant Feature Transform method as elaborated above and the performing of features extraction in the feature extractor 11 on the encoding side 1 may comprise for example calculation of SIFT keypoints.

In the encoding side 1 there is further provided a stitcher 13 in which there is performed stitching and/or transforming of the obtained plurality of feature maps 12, extracted from the multiview picture data 10, to obtain at least one panoramic map of features 14. The panoramic map of features may be, for example cubic, cylindrical or spherical representation of the plurality of feature maps 12. In the stitcher 12 the stitching and/or transforming may be performed, for example, based on overlapping features maps of the plurality of feature maps 12 extracted from the multiview picture data 10. With transforming, for example, redundant elements and/or information may be removed. The particular way of stitching and/or transforming of the obtained plurality of feature maps 12 from the multiview picture data 10 to obtain at least one panoramic map of features 14 is not limiting to the present invention.

In the encoding side 1 there is further provides a transformer 16 in which it is performed transforming of the multiview picture data 10 to select a plurality of patches of view 17 of the multiview picture data 10. For example, in the transformer 16 there is performed transformation of the multiview picture data (of the individual input views), by performing searching and cropping of overlapping regions based on the plurality of features maps 12 and the at least one panoramic map 14 to reduce redundant information and to thereby select the plurality of patches of view 17. This is shown, for example in FIG. 2B, with dashed arrows. One or more than one patch of view may be selected from each individual view. It is also possible that from some individual views no patch of view is selected. The way of selecting the plurality of patches of view 17 may be any suitable method. In other words, the present invention is not limited to any particular way of selecting the plurality of patches of view 17.

As elaborated above, each patch of view is any one of an individual view of the multiview picture data 10, a part of an individual view or a combination of at least two parts of an individual.

In the encoding side 1 there is further provided a first encoder 15 in which it is performed encoding the at least one panoramic map of features 14.

In the encoding side 1 there is further provided a second encoder 18 in which it is performed encoding the plurality of patches of view 17.

The encoding in the first encoder 15 may comprise performing compressing of the at least one panoramic map of features 14. Similarly, the encoding in the second encoder 18 may comprise performing compressing of the plurality of patches of view 17. In the following, the words encoding and compressing may be interchangeably used.

In the first encoder 15 and the second encoder 18 the encoding the at least one panoramic map of features 14 and the encoding the plurality of patches of view 17 are performed independently from each other.

The first encoder 15 and the second encoder 18 may also be placed in a single encoder, however, even when placed in a single encoder the encoding the at least one panoramic map of features 14 and encoding the plurality of patches of view 17 are performed independently from each other. For example such single encoder may have two input ports, one for the at least one panoramic map of features 14 and one for the plurality of patches of view 17 to thereby encode the at least one panoramic map of features 14 and the plurality of patches of view 17 independently from each other and may respectively have two output ports to output respectively the encoded at least one panoramic map of features 14 and the encoded plurality of patches of view 17.

In addition, in the second encoder 18, the encoding of the plurality of patches of view 17 may comprise encoding independently each one of the patches of view 17.

The first encoder 15 which generates the encoded at least one panoramic map of features by performing encoding of the at least one panoramic map of features 14 may apply various encoding methods applicable for encoding the at least one panoramic map of features 14. More specifically, the first encoder 15 may apply various encoding methods applicable for encoding in general pictures such as still images and/or videos. The first encoder 15 applying various encoding methods applicable for encoding in general still images and/or videos may comprise the first encoder 15 applying a predetermined encoding codec. Such encoding codec may comprise encoding codec for encoding images or videos such as any one of the Joint Photographic Experts Group, JPEG, JPEG 2000, JPEG XR etc., Portable Network Graphics, PNG, Advanced Video Coding, AVC (H.264), Audio Video Standard of China (AVS), High Efficiency Video Coding, HEVC (H.265), Versatile Video Coding, VVC (H.266) or AOMedia Video 1, AV1 codec. In general, the first encoder 15 may apply a lossy or lossless compression (encoding) of the at least one panoramic map of features 14. The used specific encoding codec is not to be seen as limiting to the present invention.

Similarly, the second encoder 18 which generates the encoded plurality of patches of view by performing encoding to the plurality of patches of view 17 may apply any on the above-mentioned encoding codec. The first encoder 15 and the second encoder 18 may apply the same encoding codec but may also apply a different encoding codec. This is possible, since as elaborated above, in the first encoder 15 and the second encoder 18 the encoding the at least one panoramic map of features 14 and the encoding the plurality of patches of view 17 are performed independently from each other. Accordingly, it is possible to adjust (or control) the quality of the encoded at least one panoramic map of features and the encoded plurality of patches of view independently from each other. More specifically, the high quality of the panoramic map of features 14 can be preserved in this way using appropriate coding method.

The encoded or compressed at least one panoramic map of features, which in general may be represented as a bitstream, is outputted to a first transmitter 50-1, for example any kind of communication interface configured to transmit the encoded at least one panoramic map of features 14 over a communication network to a decoding side 2. The communication network may be any wired or wireless mobile network.

In other words, in the encoding side 1 there is further provided a first transmitter 50-1 for transmitting the encoded at least one panoramic map of features, normally as a bitstream, to the decoding side 2 for decoding.

Similarly, the encoded or compressed plurality of patches of view may be represented as a bitstream which is outputted to a second transmitter 50-2, for example, any kind of communication interface configured to transmit the encoded plurality of patches of view 17 represented as a bitstream over a communication network. The communication network may be any wired or wireless mobile network.

In other words, in the encoding side 1 there is further provided a second transmitter 50-2 for transmitting the encoded plurality of patches of view, normally as a bitstream, to the decoding side 2 for decoding.

In the first transmitter 50-1 and the second transmitter 50-2 the transmitting the encoded at least one panoramic map of features to the decoding side 2 for decoding and transmitting the encoded plurality of patches of view to the decoding side for decoding are performed independently from each other.

The first transmitter 50-1 and the second transmitter 50-2 may be arranged in a single transmitter 50, however, even when arranged in a single transmitter the transmitting the encoded at least one panoramic map of features to the decoding side 2 for decoding and transmitting the encoded plurality of patches of view to the decoding side for decoding are performed independently from each other. For example, such transmitter may comprise two input ports, one for the encoded at least one panoramic map of features to be fed in and one for the encoded plurality of patches of view to be fed in and may also comprise two output ports, one for the transmitting the encoded at least one panoramic map of features and one for transmitting the encoded plurality of patches of view, to thereby transmit the encoded at least one panoramic map of features and the encoded plurality of patches of view independently from each other.

In an implementation, a module may be used to multiplex the encoded at least one panoramic map of features and the encoded plurality of patches of view to form a single bitstream which is transmitted by a transmitter. In another implementation, the module may be within the transmitter.

In another implementation, the encoded at least one panoramic map of features and the encoded plurality of patches of view may be transmitted by a multiplex transmitter. In other words, the multiplex transmitter may be used to multiplex the encoded at least one panoramic map of features and the encoded plurality of patches of view to form a single bitstream.

In a complementary manner a module may be used in the decoding side 2 or between the encoding side 1 and the decoding side 2 to demultiplex the multiplexed encoded at least one panoramic map of features and the encoded plurality of patches of view to form two bitstreams which are provided for processing in the decoding side 2.

At the decoding side 2 there is provided at least one communication interface configured to receive communication data conveying the encoded at least one panoramic map of features and the encoded plurality of patches of view over a communication network, which may be, as elaborated above, any wired or wireless mobile network. In other words, the communication interface is adapted to perform communication over a wired or a wireless mobile network. The at least one communication interface is configured to receive (or obtain) independently the encoded at least one panoramic map of features and the encoded plurality of patches of view. For example, the at least one communication interface may comprise two input ports and two output ports. One set of input port and output port is used for receiving and outputting to a first decoder 21 provided in the decoding side 2 the encoded at least one panoramic map of features and one set of input port and output port is used for receiving and outputting to a second decoder 22 provided in the decoding side 2 the encoded plurality of patches of view.

Accordingly, in the decoding side 2 there is provided a first decoder 21 in which there is performed obtaining the at least one encoded panoramic map of features and decoding (or decompressing) the obtained at least one encoded panoramic map of features to thereby generate a decoded (or decompressed) at least one panoramic map of features 23. In the present description the words decoding and decompressing may be interchangeably used.

Further, accordingly, in the decoding side 2 there is provided a second decoder 22 in which there is performed obtaining the plurality of encoded patches of view of the multiview picture data 10 and performing decoding (or decompressing) on the obtained plurality of encoded patches of view to thereby obtain a decoded (or decompressed) plurality of patches of view 24.

In the decoding side there is further provided a feature extractor 25 in which there is performed extraction of features (feature extraction) from the decoded plurality of patches of view 24 to obtain a plurality of feature maps 26. Similar to the feature extractor 11 provided in the encoding side, in the feature extractor 25 provided in the decoding side 2 the extraction of features is performed by applying a predetermined feature extraction method. The predetermined feature extraction method may be any one of the predetermined feature extraction methods elaborated with respect to the feature extractor 11 on the encoding side 1 or may be other feature extraction method chosen according to the specific needs, such as computation power, accepted latency and etc.

In the decoding side 2 there is further provided a matcher 27 in which there is performed matching of the obtained plurality of feature maps 26 with the decoded panoramic map of features 23 to obtain the position of each patch of view of the plurality of patches of view in a panoramic picture data 29. For the process of matching any suitable matching method may be used. In other words, the present invention is not limited to a particular matching method.

In the decoding side 2 there is further provided a stitcher 28. The decoded plurality of patches of view 24 is also fed from the second decoder 22 into the stitcher 28 in which there is performed stitching of the decoded plurality of patches of view 24 to obtain the panoramic picture data 29 based on the obtained position of each patch of view in the matcher 27. In other words, information for the obtained position of each patch of view from the plurality of patches of view 24 is fed from the matcher 27 in the stitcher 28 which uses this information to respectively stitch the decoded plurality of patches of view 24 fed from the second decoder 22 to thereby obtain (or reconstruct) panoramic picture data 29.

As elaborated above, panoramic picture data 29 may be understood as data that is, contains, indicates and/or can be processed to obtain at least in part a (reconstructed) panoramic view. The panoramic view includes data that is, contains, indicates and/or can be processed to obtain a panoramic image, a panoramic picture, a stream of panoramic pictures/images, a panoramic video, a panoramic movie, and the like, wherein, in particular, a panoramic stream, panoramic video or a panoramic movie may contain one or more pictures. For simplicity, in the description here below the term panoramic view is used in the sense of panoramic image or panoramic video.

This obtained panoramic picture data 29 may be output from the stitcher 28 for further processing in the decoding side 2, for example for a display on a display 200-2 of the mobile device 200-1 elaborated with respect to FIG. 1A above or other processing. The obtained panoramic picture data 29 may be at least a partly reconstructed panoramic view.

In this way, according to the present invention, the reconstruction of the panoramic view on the decoding side 2 is performed using the decoded panoramic map of features 23 and the decoded plurality of patches of view 24. Therefore, the information about location and transformation of each patch of view of the plurality of patches of view 24 in the obtained panoramic picture data 29 is concluded from the matching between the decoded panoramic map of features 23 and features of the plurality of patches of view 24.

Because the encoding the panoramic map of features 14 and encoding the plurality of patches of views 17 are performed independently from each other, the quality of both can be adjusted independently as elaborated above. Especially, the high quality of the encoded panoramic map of features 14 can be preserved, using appropriate coding method. Since the decoded panoramic map of features 23 whose high quality can be preserved in this way is used for obtaining (reconstructing or generating) the panoramic picture data 29, the quality of the obtained (reconstructed) panoramic picture data 29 and hence the quality of the at least in part reconstructed panoramic view is also increased.

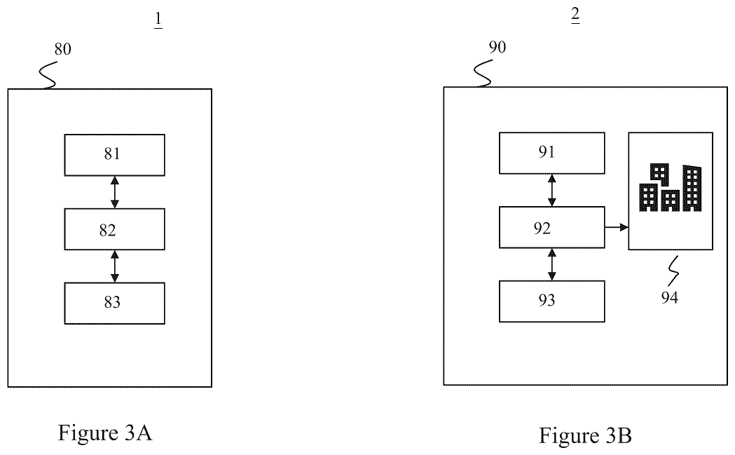

FIG. 3A shows a schematic view of a general device embodiment for the encoding side 1 according to an embodiment of the present invention. An encoding device 80 comprises processing resources 81, a memory access 82 as well as a communication interface 83. The mentioned memory access 82 may store code or may have access to code that instructs the processing resources 81 to perform the one or more steps of any method embodiment of the present invention a as described and explained in conjunction with the present disclosure.

Specifically, the code may instruct the processing resources 81 to perform extraction of features from multiview picture data 10 to obtain a plurality of feature maps 12; to perform stitching and/or transforming of the obtained plurality of feature maps 12 to obtain at least one panoramic map of features 14; perform transforming of the multiview picture data 10 to select a plurality of patches of view 17 of the multiview picture data; encode the at least one panoramic map of features 14; and encode the plurality of patches of view 17.

The processing resources 81 may be embodied by one or more processing units, such as a central processing unit (CPU), or may also be provided by means of distributed and/or shared processing capabilities, such as present in a datacentre or in the form of so-called cloud computing.

The memory access 82 which can be embodied by local memory may include but not limited to, hard disk drive(s) (HDD), solid state drive(s) (SSD), random access memory (RAM), FLASH memory. Likewise, also distributed and/or shared memory storage may apply such as datacentre and/or cloud memory storage.

The communication interface 83 may be adapted for receiving data conveying the multiview picture data 10 as well as for transmitting communication data conveying the encoded at least one panoramic map of features and the plurality of encoded patches of view over a communication network. The communication network may be a wired or a wireless mobile network.

FIG. 3B shows a schematic view of a general device embodiment for the decoding side 2 according to an embodiment of the present invention. A decoding device 90 comprises processing resources 91, a memory access 92 as well as a communication interface 93. The mentioned memory access 92 may store code or may have access to code that instructs the processing resources 91 to perform the one or more steps of any method embodiment of the present invention an as described and explained in conjunction with the present disclosure. The communication interface 93 may be adapted for receiving communication data conveying the encoded at least one panoramic map of features and the plurality of encoded patches of view over a network. The network may be a wired network or a wireless mobile network. The communication interface 93 may in addition be adapted for transmitting communication data conveying the above-elaborated panoramic picture data 29.

Further, the device 90 may comprise a display unit 94 that can receive display data from the processing resources 91 so as display content in line with the display data. The display data may be based on the panoramic picture data 29 elaborated above. The device 90 can generally be a computer, a personal computer, a tablet computer, a notebook computer, a smartphone, a mobile phone, a video player, a tv set top box, a receiver, etc. as they are as such known in the arts.

Specifically, the code may instruct the processing resources 91 to obtain at least one encoded panoramic map of features; perform decoding of the obtained at least one encoded panoramic map of features; obtain a plurality of encoded patches of view of a multiview picture data; perform decoding on the obtained plurality of encoded patches of view; perform extraction of features from the decoded plurality of patches of view to obtain a plurality of feature maps; perform matching of the obtained plurality of feature maps with said decoded panoramic map of features to obtain the position of each patch of view of the plurality of patches of view in a panoramic picture data.

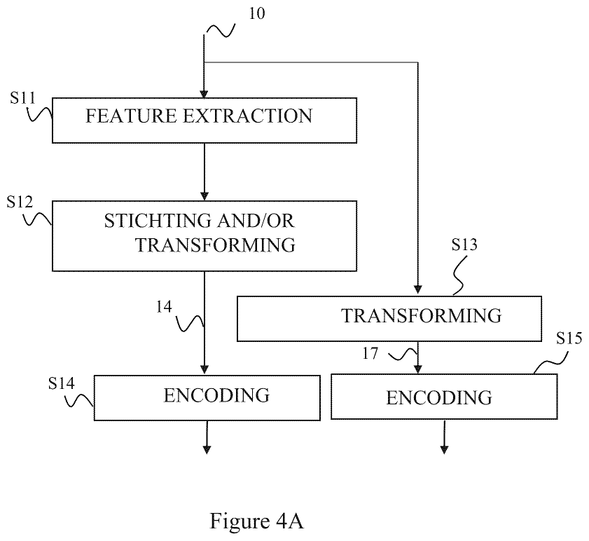

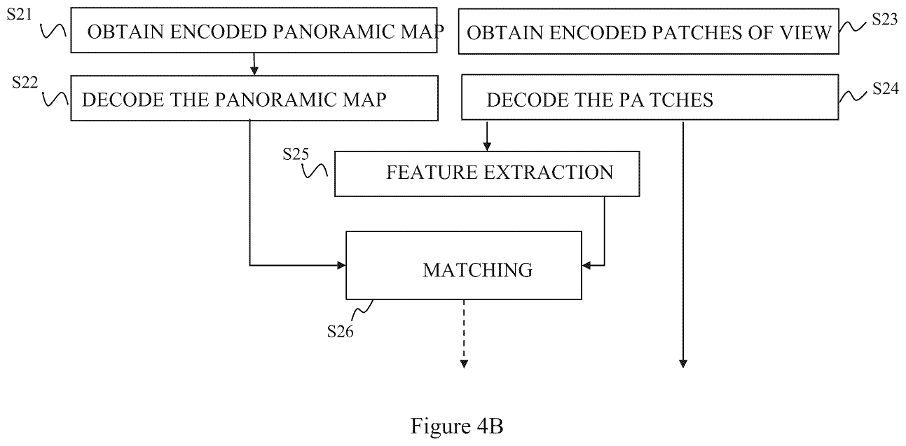

FIG. 4A shows a flowchart of general method embodiment of the present invention that refers to encoding multiview video data. Specifically, the embodiment provides a method for multiview video data encoding comprising the steps of: performing extraction of features (S11) from multiview picture data 10 to obtain a plurality of feature maps; performing stitching and/or transforming (S12) of the obtained plurality of feature maps to obtain at least one panoramic map of features 14; performing transforming (S13) of the multiview picture data to select a plurality of patches of view 17 of the multiview picture data; encoding (S14) the at least one panoramic map of features 14; and encoding (S15) the plurality of patches of view 17.

FIG. 4B shows a flowchart of a general method embodiment of the present invention which relates to decoding of multiview data 10. More specifically the embodiment provides a method multiview video data decoding comprising the steps of: obtaining (S21) at least one encoded panoramic map of features; performing decoding (S22) of the obtained at least one encoded panoramic map of features; obtaining (S23) a plurality of encoded patches of view of a multiview picture data; performing decoding (S24) on the obtained plurality of encoded patches of view; performing extraction (S25) of features from the decoded plurality of patches of view 24 to obtain a plurality of feature maps 26; and performing matching (S26) of the obtained plurality of feature maps 26 with said decoded panoramic map of features 23 to obtain the position of each patch of view of the plurality of patches of view in a panoramic picture data 29.

In summary, according to the embodiments of the present invention there is provided a transmission of (complete) panoramic map of features 14 from an encoding side 1 to a decoding side 2 and building the panoramic picture data 29 on the decoding side 2 form the received and decoded panoramic map of features 23 and received and decoded patches of view 24. Hence, a panoramic view does not need to be produced on the encoding side 1 as elaborated in respect to FIG. 1B and FIG. 1C. In other words, there is no need for stitching the panoramic view 28-1 on the encoding side 1 and encoding the stitched panoramic view. Since according to the present invention, the encoding of the at least one panoramic map of features 14 and encoding of the plurality of patches of views 17 are independent from each other, the quality of both can be adjusted independently from each other. In particular, the high quality of the at least one panoramic map of features can be preserved using appropriate coding method.

In general, the skilled person will understand that the exact method for encoding of multiview picture data 10 can be chosen according to the available computing power, acceptable latency etc.

Although detailed embodiments have been described, these only serve to provide a better understanding of the invention defined by the independent claims and are not to be seen as limiting.

### LIST OF REFERENCE SIGNS

1 encoding side
2 decoding side
100-1, 100-2 equipment on encoding side
200-1 equipment on decoding side
200-2 display of equipment on decoding side
10 multiview picture data
11 feature extractor on encoding side
12 plurality of feature maps on encoding side
13 stitcher on encoding side
14 panoramic map of features on encoding side
15 first encoder
16 transformer
17 patches of view on encoding side
18 second encoder
21 first decoder
22 second decoder
23 panoramic map of features on decoding side
24 patches of view on decoding side
25 feature extractor on decoding side
26 plurality of feature maps on decoding side
27 matcher on decoding side
28 stitcher on decoding side
29 reconstructed panoramic view/panoramic picture data
28-1 panoramic view on encoding side
28-2 decoded panoramic view
30 encoder
50 transmitting, transmitter
50-1 first transmitter
50-2 second transmitter
60 decoder

1. A method for multiview picture data encoding comprising:
performing extraction of features from multiview picture data to obtain a plurality of feature maps;
performing stitching and/or transforming of the obtained plurality of feature maps to obtain at least one panoramic map of features;
performing transforming of the multiview picture data to select a plurality of patches of view of the multiview picture data;
encoding the at least one panoramic map of features; and
encoding the plurality of patches of view.

2. The method according to claim 1, wherein the multiview picture data comprises a plurality of individual views.

3. The method according to claim 1, wherein the steps of encoding the at least one panoramic map of features and encoding the plurality of patches of view are performed independently from each other.

4. The method according to claim 1, wherein the encoding of the plurality of patches of view comprises encoding independently each one of the patches of view.

5. The method according to claim 1, further comprising the steps of:
transmitting the encoded at least one panoramic map of features to a decoding side for decoding; and
transmitting the encoded plurality of patches of view to the decoding side for decoding.

6. The method according to claim 5, wherein the steps of transmitting the encoded at least one panoramic map of features to a decoding side for decoding and transmitting the encoded plurality of patches of view to a decoding side for decoding are performed independently from each other.

7. The method according to claim 1, further comprising:
obtaining said multiview picture data.

8. The method according to claim 1, wherein the step of performing stitching and/or transforming of the obtained plurality of feature maps to obtain at least one panoramic map of features is based on overlapping feature maps extracted from the multiview picture data.

9. The method according to claim 1, wherein the step of performing transforming of the multiview picture data comprises performing searching and cropping overlapping regions based on the plurality of features maps and the at least one panoramic map of features to select the plurality of patches of view.

10. The method according to claim 1, wherein each patch of view is any one of an individual view, a part of an individual view or a combination of at least two parts of an individual view.

11. The method according to claim 2, wherein said each one of the individual views and/or includes data that is, contains, indicates and/or can be processed to obtain an image, picture, a stream of pictures/images, a video, a movie, and/or each one of the individual views is captured by at least one image capturing unit, each image capturing unit looking at a different direction.

12. A method for multiview picture data decoding comprising:
obtaining at least one encoded panoramic map of features;
performing decoding of the obtained at least one encoded panoramic map of features;
obtaining a plurality of encoded patches of view of a multiview picture data;
performing decoding on the obtained plurality of encoded patches of view;
performing extraction of features from the decoded plurality of patches of view to obtain a plurality of feature maps; and
performing matching of the obtained plurality of feature maps with said decoded panoramic map of features to obtain a position of each patch of view of the plurality of patches of view in a panoramic picture data.

13. The method according to claim 12, further comprising:
performing stitching of the plurality of patches of view to obtain the panoramic picture data based on the obtained position of each patch of view.

14. The method according to claim 12, wherein the obtained panoramic picture data is at least a partly reconstructed panoramic view.

15. The method according to claim 12, wherein said each one of the individual views is and/or includes data that is, contains, indicates and/or can be processed to obtain an image, picture, a stream of pictures/images, a video, a movie, and/or each one of the individual views is captured by at least one image capturing unit, each image capturing unit looking at a different direction.

16. The method according to claim 12, wherein said panoramic picture data includes data that is, contains, indicates and/or can be processed to obtain a at least in part a panoramic view, wherein said panoramic view is a continuous view of a scene in at least two directions, said panoramic view including data that is, contains, indicates and/or can be processed to obtain a panoramic image, a panoramic picture, a stream of panoramic pictures/images, a panoramic video, a panoramic movie.

17. A multiview picture data decoding device, comprising:
a processor and a memory, the memory storing code that, when executed by the processor, causes the following operations to be performed:
obtain at least one encoded panoramic map of features;
perform decoding of the obtained at least one encoded panoramic map of features;
obtain a plurality of encoded patches of view of a multiview picture data;
perform decoding on the obtained plurality of encoded patches of view;
perform extraction of features from the decoded plurality of patches of view to obtain a plurality of feature maps; and
perform matching of the obtained plurality of feature maps with said decoded panoramic map of features to obtain a position of each patch of view of the plurality of patches of view in a panoramic picture data.

18. The multiview picture data decoding device according to claim 17 further comprising a communication interface configured to receive communication data conveying the encoded at least one panoramic map of features and the plurality of encoded patches of view over a communication network.

19. The multiview picture data decoding device according to claim 18, wherein the communication interface is adapted to perform communication over a wired or wireless mobile network.
